(19) United States
(12) Patent Application Publication
(10) Pub. No.: US 2012/0038213 A1
(43) Pub. Date: Feb. 16, 2012

(54) NON-CHARGING BATTERY BACKUP UNIT (BBU)

(76) Inventors: Mark O. Vogel, Statesville, NC (US); John Williams, Hickory, NC (US); Mark Robert Rowe, Boca Raton, FL (US); Thomas Edward Raviele, Hollywood, FL (US); Ronald Howard Diego, Boca Raton, FL (US); Jerry Darden Vereen, Coral Springs, FL (US)

(21) Appl. No.: 13/198,768

(22) Filed: Aug. 5, 2011

Related U.S. Application Data
(60) Provisional application No. 61/372,131, filed on Aug. 10, 2010.

(51) Int. Cl. H02J 9/00

(52) U.S. Cl. 307/64

(57) ABSTRACT

A battery backup unit (BBU) includes a housing, at least one battery compartment in the housing with an output terminal, a DC input, a DC output, a path from the DC input to the DC output, circuitry for selectively connecting the output terminal to the path, which circuitry includes a switch, and a controller configured to detect a condition of the path and selectively control the switch to connect the output terminal to the path when the condition is detected, the BBU being incapable of charging batteries in the at least one battery compartment. The path from the DC input to the DC output may include a DC/DC step up converter to help maintain a constant output voltage.

### CROSS-REFERENCE TO RELATED APPLICATIONS

The present application claims the benefit of U.S. Provisional Patent Application No. 61/372,131 filed Aug. 10, 2010, the entire contents of which are hereby incorporated by reference.

### FIELD OF THE INVENTION

The present invention is directed to a battery backup unit (BBU) having a DC input, a DC output, a compartment for removably receiving a plurality of batteries and a controller for connecting the batteries to the DC output when no current is detected at the DC input and, more specifically, toward a BBU having a DC input, a DC output, a compartment for removably receiving a plurality of batteries and a controller for connecting the batteries to the DC output when no current is detected at the DC input, wherein the BBU is incapable of charging the batteries in the battery compartment.

### BACKGROUND OF THE INVENTION

In conventional telephone systems, power and data are provided over wires that connect a customer's home to a telephone central office. In newer telephone systems, data may be provided over an optical fiber that terminates at an optical network unit (ONU) or network interface unit (NIU) located at a customer's home or business. These systems are referred to as fiber-to-the-home (FTTH) systems. Power cannot be transmitted over the optical fiber, and therefore, power for operating the ONU and its internal laser and optical/electric converters is generally provided from the customer premises via a DC converter connected to an AC power source (e.g., a wall outlet) at the customer premises. In the event of a power outage at the customer premises, telephone service in a FTTH system will be lost unless backup power is provided. However, most customer locations do not have a source of backup power.

To address this problem, it is known to provide a battery backup unit (BBU) at the subscriber location that provides power to the ONU in the event of a power failure. Traditional backup systems contain an AC/DC converter to power the ONU while power is available, and they also provide power to a charging system that keeps a battery system charged for use when power is interrupted. When main power is lost, the BBU switches to the battery system which then powers the ONU. When the backup battery is depleted, service is lost until the main power returns.

To make the BBU easy to use for a customer, the battery is usually packaged in a custom plastic enclosure with an integrated electrical connector. The battery pack is then easily handled and put into or removed from the BBU. In addition, the battery pack recharges while connected to AC power so that a customer does not need to maintain or monitor the charge on the battery.

There are several drawbacks to this approach to providing backup power. The first is the complexity of charging and maintaining a charge on a battery. The correct voltages, currents, charge durations, and charge frequencies are highly dependent on the battery technology used (lithium ion, nickel cadmium, etc.), and even within a given technology, these characteristics are dependent on the composition of the battery. As a result, a charger must either be custom tuned in the factory for a particular battery type and composition, or it must be field adaptable to accommodate different batteries. In addition, in either scenario, if new battery technology is developed, even if it has the same voltage and current characteristics, its charging requirements may not be accommodated by the charger. It therefore may be necessary to redesign or field-upgrade the BBU when new battery technology is developed.

Custom battery packs are beneficial for ease of customer use, but customization also means that these battery packs may not be readily available at retail outlets. As a result, in the event of an outage that exceeds the battery backup duration, or when the battery system fails during an outage, a customer will not be able to maintain service because there is no way to readily procure another battery. A customer might own a second battery pack, but even that will not help if the charge on that second battery pack is not maintained.

Conventional BBU's also have an integral power supply which takes in an AC voltage and converts it to DC. While needed for the backup system to operate, this function is redundant in many FTTH systems since ONU's generally have their own power supplies. When battery backup is added to the ONU, the existing power supply is removed and the BBU is inserted. While the removed power supply could be used as a spare for an ONU without a BBU, in general it will be an unnecessary cost addition for the BBU.

In addition, the service provider is generally responsible for the safety of the BBU. Some of the custom batteries used in BBU's are susceptible to fire and/or explosion under certain conditions, and BBU's with rechargeable batteries make safety assurance more complex. The service provider may also need to store a large number of battery packs for use in new installations and may be required to provide safe disposal facilities for exhausted battery packs. Often this means additional costs for safety elements/features in the system and testing for safety approval from bodies such as Underwriter Laboratories (UL). It would therefore be desirable to provide a BBU for an ONU that does not suffer from the aforementioned shortcomings.

### SUMMARY OF THE INVENTION

These problems and others are addressed by embodiments of the present invention, a first aspect of which comprises a battery backup unit (BBU) that includes a housing and at least one battery compartment in the housing that has an output terminal. The BBU further includes at least one DC input, a DC output, a path from the at least one DC input to the DC output, and circuitry connecting the output terminal to the path which circuitry includes a switch for selectively connecting the output terminal to the path. The circuitry precludes current flow from the at least one DC input to the output terminal, and a controller is provided to detect a condition of the path and to selectively control the switch when the condition is detected.

Another aspect of the invention comprises a BBU that has a housing and at least one battery compartment in the housing which has an output terminal. The BBU also includes a DC input, a DC output, a path from the DC input to the DC output and circuitry for selectively connecting the output terminal to the path, which circuitry includes a switch. A controller is configured to detect a condition of the path and to selectively control the switch to connect the output terminal to the path when the condition is detected, and the BBU is incapable of charging batteries in the at least one battery compartment.

A further aspect of the invention comprises a BBU having a housing and at least one battery compartment in the housing that includes a battery terminal. The BBU also includes a DC input, a DC output, a DC path from the DC input to the DC output and a control mechanism for controlling current flow at the battery terminal and a circuitry arrangement for selectively connecting the battery terminal to the path. The control mechanism includes a controller for detecting a condition of the path and controlling the circuitry arrangement to selectively connect the battery terminal to the path when the condition is detected.

### BRIEF DESCRIPTION OF THE DRAWINGS

These and other aspects and features of embodiments of the invention will be better understood after a reading of the following detailed description together with the attached drawings wherein:

FIG. 1 is a schematic illustration of a battery backup unit according to the present invention connected to a network interface unit.

FIG. 2 is perspective view of the battery backup unit of FIG. 1.

FIG. 3 is a circuit diagram showing exemplary circuitry for use in a battery backup unit according to an embodiment of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

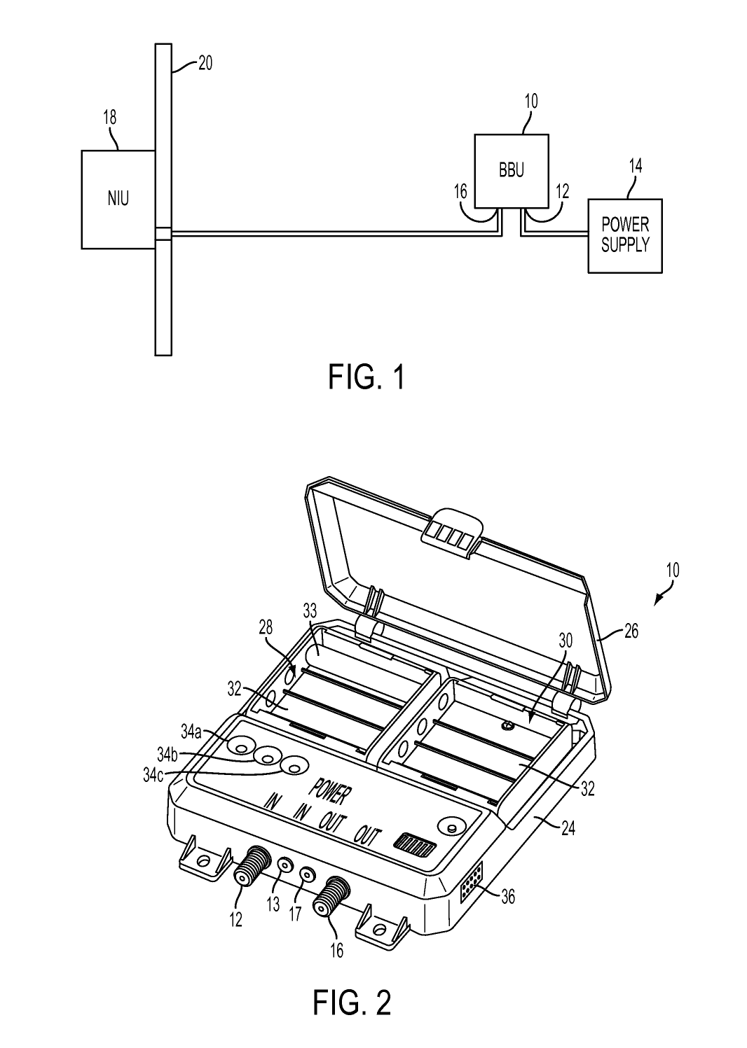

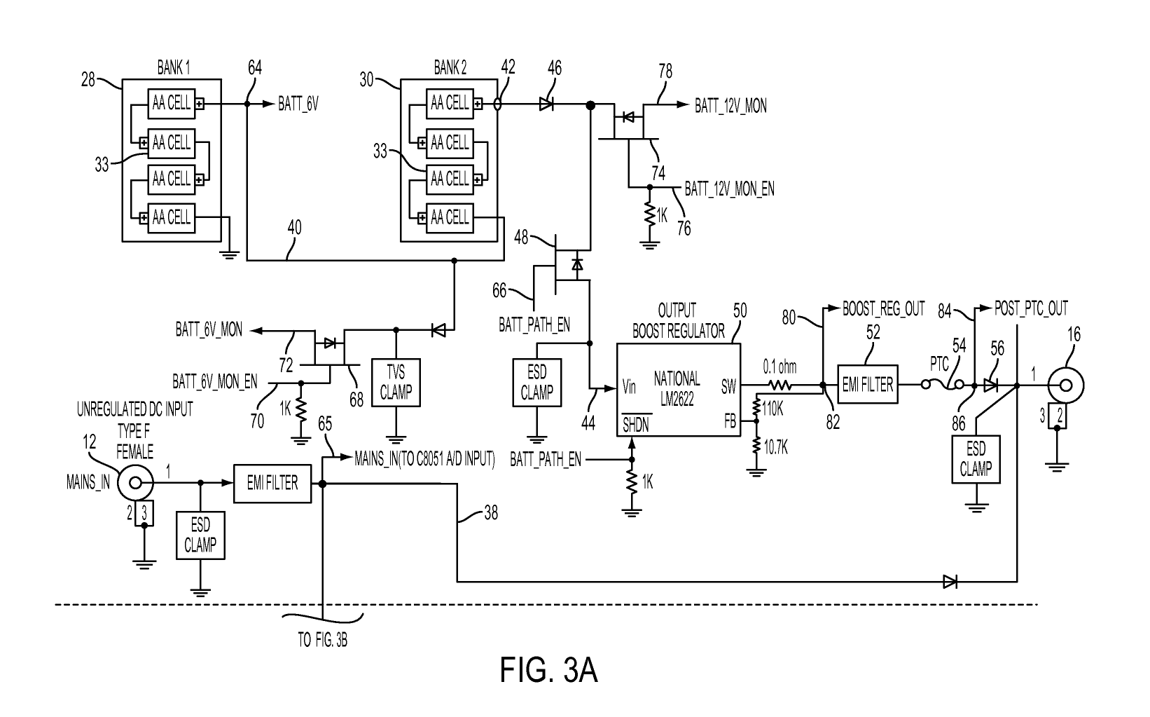

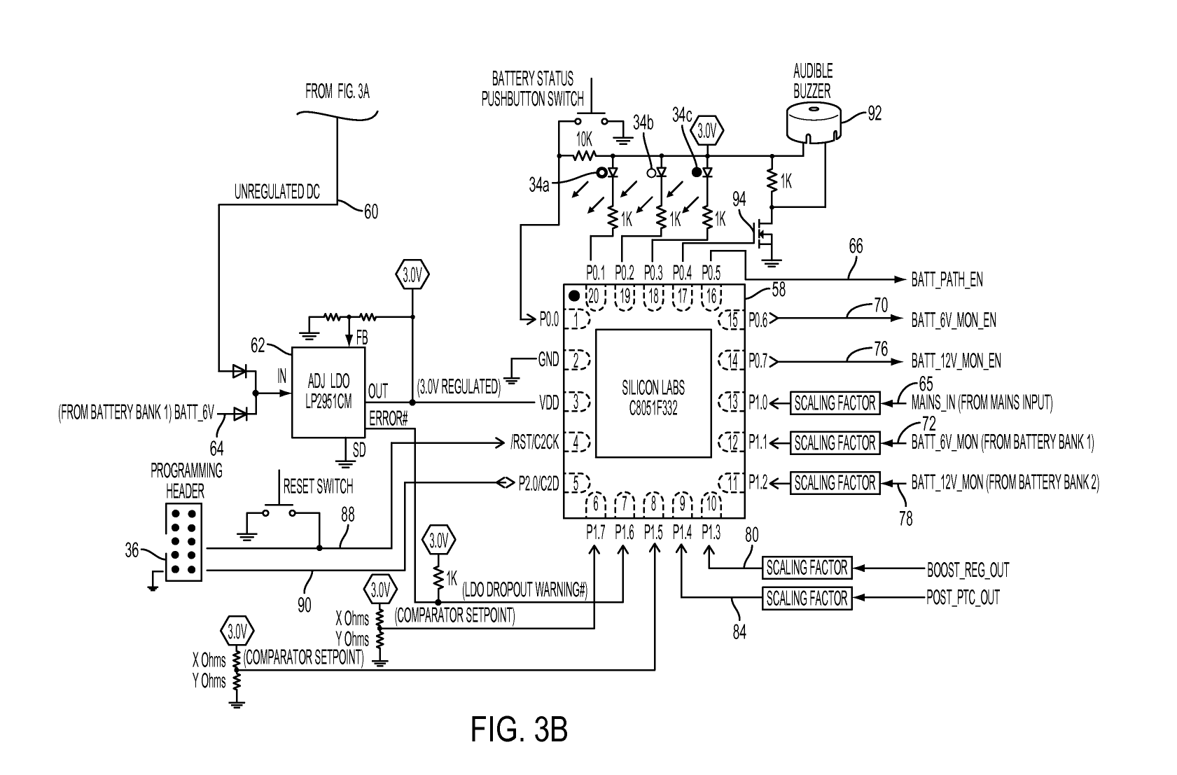

FIGS. 1 and 2 illustrate a battery backup unit (BBU) 10 according to an embodiment of the present invention that includes a first DC input 12 and a second DC input 13, either one of which is connectable to a power supply 14, and a first DC output 16 and a second DC output 17, either one of which is connectable to a network interface unit (NIU) 18 mounted on the wall 20 of a building. The first DC input 12 and first DC output 16 may comprise, for example F connectors while the second DC input 13 and the second DC output 17 may comprise barrel connectors. The first and second DC inputs 12, 13 connect to the same input node and the first and second DC outputs 13, 17 connect to the same output node and allow for different types of connectors to be used with the BBU 10. As shown in FIG. 2, the BBU 10 also comprises a housing 24 having a hinged lid 26 for selectively covering and allowing access to a first battery compartment 28 and a second battery compartment 30. Each of the first and second battery compartments 28, 30 includes a plurality of locations 32 for receiving a battery 33, in this case a standard AA battery, connected to circuitry, illustrated in FIG. 3, and enclosed within housing 24. A plurality of visual indicators 34a, 34b and 34c, which may comprise, for example, LED's, and a data port 36 are provided on the housing 24 and connected to the circuitry inside housing 24 as described hereafter.

FIG. 3 illustrates circuitry contained within housing 24 which may comprise, for example elements on a circuit board interconnected by traces or otherwise electrically coupled. The circuitry include a first path 38 that electrically connects input 12 to output 16 and allows for a substantially unregulated DC power flow from power supply 14 to NIU 18 via BBU 10 under normal operating conditions when DC power is provided to input 12 by power supply 14. First battery compartment 28 is connected in series with second battery compartment 30 by a second path 40, and second battery compartment 30 includes an output terminal 42 connected to first path 38 by a third path 44 which third path 44 includes a diode 46 for preventing current flow into the second battery compartment 30, a battery path enable switch 48 for selectively interrupting third path 44, a DC/DC voltage regulator 50 for regulating the voltage supplied to first path 38 by the batteries 33, an EMI filter 52, a PTC element 54 and a second diode 56.

FIG. 3 also illustrates a controller 58 for determining whether power is being provided from input 12 to output 16 via first path 38 and closing battery path enable switch 48 when sufficient power is not being provided. Controller 58 may be a microcontroller unit (MCU) such as a Silicon Labs C8051F332 MCU, with various input/output pins connected to various circuit elements as described below. The pins of controller 58 are labeled 1-20 in FIG. 3, and these pins numbers will be referred to hereinafter.

Pin 3 of controller 58 is connected to first path 38 by a fourth path 60 which fourth path 60 includes a voltage regulator 62, such as a National Semiconductor ADJ LDO LP 2951CM, for regulating the voltage supplied to controller 58. Second path 40 between first battery compartment 28 and second battery compartment 30 includes a node 64 connected to fourth path 60 for providing 6V DC power from the batteries in first battery compartment 28 to voltage regulator 62 and thus to controller 58 when adequate power is not provided from input 12. Unregulated voltage from first path 38 is also supplied to pin 13 of controller 58 by a mains in line 65.

Battery path enable line 66 connects battery path enable switch 48 to controller pin 16, and controller 58 controls the state of battery path enable switch 48 by providing appropriate outputs on this line 66. A battery 6V monitor switch 68 is connected to second path 40 and to controller pin 15 by a battery 6V monitor enable line 70, and battery 6V monitor switch 68 is controlled by an appropriate output of controller pin 15. The output of battery 6V monitor switch 68 is connected to controller pin 12 of controller 58 by battery 6V monitor output line 72 allowing controller 58 to receive as an input an indication of the voltage being output from the batteries 33 in first battery compartment 28 and thus an indication of the charge condition of the batteries 33 in the first battery compartment 28. A battery 12V monitor switch 74 is connected to third path 44 and to controller pin 14 by a battery 12V monitor enable line 76, and battery 12V monitor switch 74 is controlled by an appropriate output of controller pin 14. The output of battery 12V monitor switch 74 is connected to controller pin 11 of controller 58 by a battery 12V output line 78 allowing controller 58 to receive as an input an indication of the voltage being output from the batteries 33 in first and second battery compartments 28, 30 and thus an indication of the charge condition of the batteries in the first and second compartments 28, 30. When the output of the batteries 33 reaches a level greater than zero but too low to provide adequate power to NIU 18, controller 58 opens battery path enable switch 48 and shuts off power to the output terminal 16.

A boost reg out line 80 connects a node 82 in third path 44 between DC/DC voltage regulator 50 and EMI filter 52 to controller pin 10, and a post PTC out line 84 connects a node 86 between PTC element 54 and second diode 56 to controller pin 14 to provide controller 58 with additional information about voltage levels in the system. Controller pins 4 and 5 are connected to data port 36 by lines 88 and 90, respectively, for allowing communication between data port 36 and controller 58. First visual indicator 34a is connected to controller pin 20, second visual indicator 34b is connected to controller pin 19 and third visual indicator 34c is connected to controller pin 18, and a buzzer 92 is connected to controller port 17 by a switch 94 so that controller 58 can control the first, second and third visual indicators 34a, 34b, 34c and buzzer 92 to provide information about the power source being used by the BBU 10 and the condition of the batteries 33.

Under normal operating conditions, DC power is supplied to BBU input 12 and output from BBU output 16 with power also being supplied to voltage regulator 62 via fourth path 60 and to pin 13 of controller 58 via mains in line 65. The controller 58 monitors the voltage on first path 38 via mains in line 65 and, if this voltage drops below a predetermined level, a level consistent with the lowest expected normal voltage from power supply 14, controller 58 closes battery path enable switch 48 within milliseconds of the detected drop to connect output terminal 42 of second battery compartment 30 to BBU output 16 over third path 44 thereby providing a substantially uninterrupted power supply from BBU output 16 even when power ceases to be supplied to first path 38 via BBU input 12. DC/DC regulator 50, which may comprise a boost regulator, helps maintain a constant voltage level at BBU output 16 even as the batteries 33 discharge, and the charge level of batteries 33 is detected by controller 58 by periodically closing battery 6V monitor switch 68 and battery 12V monitor switch 74 to obtain voltage readings for the batteries in the first and second battery compartments 28, 30 to determine their state of charge and estimated remaining life.

While power is being supplied to BBU output 16 by batteries 33, controller 58 continues to monitor the signal on mains in line 65 to determine when the voltage on first path 38 returns to a high level indicating that power is again being supplied from BBU input 12. A predetermined time after the voltage on first path 38 returns to an operating level, controller 58 opens battery path enable switch 48 to disconnect the batteries 33 in the first and second battery compartments 28, 30 from first path 38. Generally, battery path enable switch 48 is only opened after a delay, such as 30 seconds, to help avoid repeated switching of the BBU 10 in the event of transient power events, so that battery path enable switch 48 is not opened until it reasonably certain that power supply 14 is again able to reliably supply DC power to the NIU 18 via the BBU 10. This may also help prevent an oscillating condition that might occur if the mains in voltage level at the mains in pin 13 is approximately equal to the switchover voltage.

The first, second and third visual indicators 34a, 34b, 34c may be illuminated in various combinations to provide information such as whether DC power is being provided by power supply 14 or batteries 33 and information on the charge state of the batteries 33, such as “fully charged”, “partially discharged”, and “end of life” or “fully discharged.” For example, the visual indicators may be illuminated by controller 58 as follows, where first visual indicator 34a corresponds to the below “green” LED, second visual indicator 34b corresponds to the below “yellow” LED and third visual indicator 34c corresponds to the below “red” LED:

1. Green—OK (Operating on Main power);

2. Green Blinking (1 second every 30 seconds)—Battery backup mode, battery fresh;

3. Yellow—Main power, batteries have between 3 hours and 6 hours of back-up time left;

4. Yellow Blinking (1 second every 30 seconds)—Battery backup mode, battery has between 3 and 6 hours of back-up time left;

5. Red—Main power, battery needs to be replaced. BBU will sound a “chirp” once every 30 seconds (similar to a reminder beep of a smoke detector when battery is exhausted);

6. Red Blinking (1 second every 30 seconds)—Battery backup mode, battery has less than 3 hours of time left. BBU will sound a “chirp” once every 30 seconds (similar to a reminder beep of a smoke detector when battery is exhausted; and

7. Red Blinking (1 second “on” 1 second “off”)—Battery missing or incorrectly installed (and sufficient power is present to allow the LED's to be illuminated).

If the batteries 33 are depleted to the point where loss of back-up power is imminent, the controller 58 will indicate this condition on the Light Emitting Diode status display, and will also provide an audible alarm via buzzer 92 to alert nearby users of this critical condition. This status information continues to be provided until the batteries 33 are exhausted or replaced by a user.

The BBU also has a battery “Test” mode which evaluates the amount of power left in the battery by displaying a “Red-Yellow-Green” power survey. This is activated by the user through a button (not illustrated) on the face plate of the BBU body. When powered from an AC source, no battery power will actually be used to make this evaluation. The batteries are “sensed” and a status of battery health is displayed for a 15 second interval, after which the BBU returns to “normal” mode. This gives the user a more detailed evaluation of the battery condition.

By not requiring the BBU 10 to charge batteries, as is commonly done with other backup power supplies, the circuitry required for charging and the associated complexities are eliminated and costs are reduced. As a consequence, no specialized battery charging circuitry or thermal management circuitry is necessary in BBU 10. As new primary cell technology becomes available, new types of batteries can be substituted directly into the first and second battery compartments 28, 30 without modifying the BBU 10. In addition, by designing around standard cells, there is no need for a custom battery pack or connector. An end user can simply procure standard batteries from any local retail shop and use them in the BBU 10. A customer is also likely to have spare batteries available. Another benefit of this approach is that as battery technologies change, the technology can be used in the BBU as long as the batteries are within the BBU's operating voltage. In addition, a customer can still use physically compatible rechargeable batteries in the BBU, but the customer will be responsible for charging those batteries with a conventional battery charger.

The present invention has been described herein in terms of a presently preferred embodiment. However, additions and changes to this embodiment will become apparent to those of ordinary skill in the relevant arts upon a reading of the foregoing description. It is intended that all such changes and additions comprise a part of the present invention to the extent they fall within the scope of the several claims appended hereto.

We claim:

1. A battery backup unit (BBU) comprising:
a housing;
at least one battery compartment in the housing including an output terminal;
at least one DC input;
a DC output;
a path from the at least one DC input to the DC output;
circuitry connecting the output terminal to the path and including a switch for selectively connecting the output terminal to the path, the circuitry precluding current flow from the at least one DC input to the output terminal; and
a controller configured to detect a condition of said path and to selectively control said switch when said condition is detected.

2. The BBU of claim 1 wherein said condition is a voltage level on said path.

3. The BBU of claim 1, wherein said circuitry includes a DC/DC converter between the output terminal and the path.

4. The BBU of claim 3, wherein said DC/DC converter comprises a step-up converter.

5. The BBU of claim 1 wherein said controller includes a first input receiving a signal indicative of the presence or absence of said condition and a first output connected to said switch.

6. The BBU of claim 1, wherein said housing includes at least one visual indicator providing a first visual indication when the condition is detected and a second visual indication different than said first visual indication when the condition is not detected.

7. The BBU of claim 1 including at least one visual indicator providing a visual indication of a remaining life of a battery in said at least one battery compartment.

8. The BBU of claim 1 including a voltage regulator connected to the path and to an input of the controller.

9. The BBU of claim 1, wherein said controller is configured to open said switch when an output from said output terminal is between a first level and a second level.

10. The BBU of claim 1 including a data port and a conductor connecting said data port to said controller.

11. The BBU of claim 1 including at least one battery removably mounted in said at least one battery compartment.

12. The BBU of claim 1 including:
a DC/DC converter between the output terminal and the path,
wherein said controller includes a first input receiving a signal indicative of the presence or absence of a first level of DC power on said path and a first output connected to said switch, and
a voltage regulator connected between the path and a regulator input of the controller.

13. The BBU of claim 12, including a data port and a conductor connecting said data port to said controller, wherein said DC/DC converter comprises a step-up converter, wherein said controller is configured to open said switch when an output from said output terminal is between a first level and a second level and wherein said housing includes at least one visual indicator providing a first visual indication when the first level of DC power is present, a second visual indication different than said first visual indication when said first level of DC power is absent and a third visual indication of remaining life of a battery in said at least one battery compartment.

14. A battery backup unit (BBU) comprising:
a housing;
at least one battery compartment in the housing including an output terminal;
a DC input;
a DC output;
a path from the DC input to the DC output;
circuitry for selectively connecting the output terminal to the path and including a switch; and
a controller configured to detect a condition of said path and to selectively control said switch to connect said output terminal to said path when said condition is detected,
wherein said BBU is incapable of charging batteries in said at least one battery compartment.

15. The BBU of claim 14 wherein said condition comprises a voltage of said path.

16. The BBU of claim 15, including
a DC/DC converter between the output terminal and the path,
wherein said controller includes a path condition input receiving a signal when said condition is detected and a first output connected to said switch, and
a voltage regulator connected between the path and a regulator input of the controller.

17. The BBU of claim 16, including
a data port and a conductor connecting said data port to a data input of said controller,
wherein said DC/DC converter comprises a step-up converter, and
wherein said housing includes at least one visual indicator providing a first visual indication when the condition is detected, a second visual indication different than said first visual indication when the condition is not detected and a third visual indication of a remaining life of a battery in said at least one battery compartment.

18. A battery backup unit (BBU) comprising:
a housing;
at least one battery compartment in the housing including a battery terminal;
a DC input;
a DC output;
a DC path from the DC input to the DC output; and
control means for controlling current flow at said battery terminal and circuitry means for selectively connecting said battery terminal to said path, said control means including a controller for detecting a condition of said path and for controlling said circuitry means to selectively connect said battery terminal to said path when said condition is detected.

19. The BBU of claim 18, wherein said condition comprises a voltage level on said path.

20. The BBU of claim 18, including at least one battery removably mounted in the at least one battery compartment, wherein said circuitry means precludes the recharging of said at least one battery while said at least one battery is mounted in said at least one battery compartment.
